(19) United States
(12) Patent Application Publication
(10) Pub. No.: US 2025/0091305 A1
(43) Pub. Date: Mar. 20, 2025

(54) METHOD OF MANUFACTURING AN INSULATED CONTAINER

(71) Applicant: SharkNinja Operating LLC, Needham, MA (US)

(72) Inventors: Simon Hughes, London (GB); Thomas Sharp, London (GB); Able Chen, Suzhou (CN); Haien Zhou, Suzhou (CN); Robert Ellis, London (GB)

(21) Appl. No.: 18/490,122

(22) Filed: Oct. 19, 2023

Related U.S. Application Data
(63) Continuation of application No. PCT/CN2023/119079, filed on Sep. 15, 2023.

(51) Int. Cl. B29D 22/00; B29K 23/00; B65D 25/04; B65D 25/34; B65D 43/16; B65D 81/38

(52) U.S. Cl. CPC B29D 22/003; B65D 25/04; B65D 25/34; B65D 43/165; B65D 81/3818; B29K 2023/12; B29K 2995/0011; B65D 2543/00194

(57) ABSTRACT

Various systems, devices, and methods for insulated containers with a drawer are provided. In general, an insulated container, such as a portable cooler, includes a drawer. The insulated container includes a main chamber and includes a drawer chamber that is separate from the main chamber and is configured to movably receive the drawer therein. The main chamber is configured to hold a cooling agent that is configured to cool any items in the main chamber and also any items in the drawer. The insulated container can be manufactured using injection molding.

### CROSS REFERENCE TO RELATED APPLICATIONS

The present application claims priority to PCT Patent Application No. PCT/CN2023/119079 filed Sep. 15, 2023, which is hereby incorporated by reference in its entirety.

### FIELD

The present disclosure generally relates to insulated containers with a drawer.

### BACKGROUND

Portable insulated containers such as coolers allow items such as beverages and foods to be kept cold while outdoors, in a vehicle, or otherwise outside a refrigerator or freezer. Portable coolers typically have an insulated internal cavity in which a cooling agent, such as ice or reusable cooler packs, is placed to help cool the items in the cooler. As the cooling agent defrosts or melts, the cooling agent itself and/or condensation from the cooling agent can cause items in the cooler to become wet. An item becoming wet may cause one or more unwelcome effects, such as making items undesirably damp, making items difficult and/or messy to handle unless cleaned with a towel or other material, damaging paper packaging of items, etc.

### SUMMARY

In general, systems, devices, and methods for insulated containers with a drawer are provided.

In one aspect, an insulated container is provided that in one embodiment includes a main chamber and a drawer chamber. The main chamber is configured to receive a cooling agent therein that is configured to cool one or more first items removably contained in the main chamber. The drawer chamber is separate from and disposed vertically below the main chamber, and the drawer chamber is configured to slidably receive a drawer therein that is configured to removably contain one or more second items therein. The insulated container also includes left, right, front, and back sidewalls that define walls the main chamber. The insulated container also includes a horizontal substantially planar wall that separates the main chamber and the drawer chamber, is configured to allow the cooling agent in the main chamber to cool the one or more second items contained in the drawer, is integrally formed with the left, right, front, and back sidewalls, has a thickness in a range of about 2.5 to about 3.5 mm, and is formed of polypropylene.

The insulated container can vary in any number of ways. For example, the horizontal substantially planar wall can be non-porous and can include a plurality of ribs. Further, the plurality of ribs can form a hexagonal pattern.

For another example, the insulated container can also include a first vertical substantially planar divider wall extending at least a partial distance from back to front and being configured to provide load-bearing support of the horizontal substantially planar wall. Further, the insulated container can also include the drawer, and, with the drawer fully slid into the drawer chamber, a back-facing surface of the drawer can be configured to abut a front-facing surface of the first vertical substantially planar divider wall; and/or the first vertical substantially planar divider wall can be centered laterally. Further, the insulated container can further includes a second vertical substantially planar divider wall extending vertically in the main chamber so as to divide the main chamber into first and second compartments, and the first vertical substantially planar divider wall can be below and vertically aligned with the second vertical substantially planar divider wall. Further, the first vertical substantially planar divider wall and the second vertical substantially planar divider wall can be centered laterally.

For yet another example, the insulated container can also include the drawer, and the insulated container can also include a lock configured to be manually moved by a user between a locked configuration, in which the lock prevents the drawer from being slidable out of the drawer chamber, and an unlocked configuration, in which the lock allows the drawer to slide at least partially out of the drawer chamber. Further, the movement can be vertical movement, or the movement can be horizontal movement.

For yet another example, the insulated container can also include the drawer, the drawer can include a handle on a front surface thereof, and, with the drawer fully slid into the drawer chamber, the drawer chamber can be sealed closed.

For still another example, each of the left, right, front, and back sidewalls can have a thickness in a range of about 2.5 to about 3.5 mm and can each be formed of polypropylene. Further, the insulated container can also include an outer housing containing therein the main chamber, the drawer chamber, the left, right, front, and back sidewalls, and the horizontal substantially planar wall, and the insulated container can also include an insulating material disposed in at least one space defined between the outer housing and the left, right, front, and back sidewalls. Further, the insulating material can include polyurethane; and/or the outer housing can be formed of an ultraviolet (UV) resistant material or can have a UV-resistant coating thereon.

For yet another example, the insulated container can also include a lid defining a top wall of the main chamber, the lid can be configured to move between a closed configuration, in which the main chamber is sealed closed, and an open configuration, in which the main chamber is not sealed closed and the one or more first items removably contained in the main chamber are accessible to a user, and, with the lid in either the open configuration or the closed configuration, the drawer chamber can be configured to be sealed closed. Further, the lid can be hingedly attached to one of the left, right, front, and back sidewalls in each of the closed and open configurations, or the lid in the open configuration can be configured to be independent from the left, right, front, and back sidewalls.

For another example, the horizontal substantially planar wall and the left, right, front, and back sidewalls can be rigid.

For yet another example, the insulated container can also include the drawer, and the drawer can include a single chamber configured to removably contain therein the one or more second items.

For still another example, the insulated container can also include the drawer, and the drawer can include a plurality of chambers each configured to removably contain therein at least one of the one or more second items.

For another example, the insulated container can further include an outer housing containing therein the main chamber, the drawer chamber, the left, right, front, and back sidewalls, and the horizontal substantially planar wall. Further, the outer housing can be formed of an ultraviolet (UV) resistant material or can have a UV-resistant coating thereon.

In another embodiment, an insulated container includes an upper housing, a lower housing, a horizontally-extending divider wall, and a first vertically-extending divider wall. The upper housing has a main chamber therein. The main chamber is configured to receive a cooling agent therein that is configured to cool one or more first items removably contained in the main chamber. The lower housing has a drawer chamber therein that is separate from the main chamber, and the lower housing is non-removably fixed to the upper housing. The drawer chamber is configured to slidably receive a drawer therein that is configured to removably contain one or more second items therein. The horizontally-extending divider wall defines a bottom wall of the upper housing and a top wall of the lower housing, is integrally formed with the upper housing, and is configured to allow the cooling agent in the main chamber to cool the one or more second items contained in the drawer. The first vertically-extending divider wall extends at least a partial distance from back to front and is configured to provide load-bearing support of the horizontally-extending divider wall.

The insulated container can have any number of variations. For example, the horizontally-extending divider wall can have a thickness in a range of about 2.5 to 3.5 mm, and the horizontally-extending divider wall can be formed of polypropylene. Further, the insulated container can also include left, right, front, and back sidewalls that define walls of the upper housing, that can each have a thickness in a range of about 2.5 to 3.5 mm, and can each be formed of polypropylene, and the horizontally-extending divider wall can be integrally formed with the left, right, front, and back sidewalls.

For another example, the first vertically-extending divider wall can be centered laterally.

For yet another example, the insulated container can also include an outer housing containing therein the upper housing, the lower housing, the horizontally-extending divider wall, and the first vertically-extending divider wall, and the insulated container can also include an insulating material disposed in at least one first space defined between the outer housing and the upper housing and in at least one second space defined between the outer housing and the lower housing. Further, the insulating material can include polyurethane; and/or the outer housing can be formed of an ultraviolet (UV) resistant material or can have a UV-resistant coating thereon.

For still another example, the horizontally-extending divider wall can be non-porous and can include a plurality of ribs. Further, the plurality of ribs can form a hexagonal pattern.

For another example, the insulated container can also include a lid defining a top wall of the main chamber, the lid can be configured to move between a closed configuration, in which the main chamber is sealed closed, and an open configuration, in which the main chamber is not sealed closed and the one or more first items removably contained in the main chamber are accessible to a user, and, with the lid in either the open configuration or the closed configuration, the drawer chamber can be configured to be sealed closed. Further, the lid can be hingedly attached to the upper housing in each of the closed and open configurations, or the lid in the open configuration can be configured to be independent from the upper housing.

For still another example, the insulated container can also include the drawer, and, with the drawer fully slid into the drawer chamber, the drawer can have first and second separate compartments configured to be disposed on either side of the first vertically-extending divider wall.

For yet another example, the insulated container can also include the drawer, and the insulated container can also include a lock configured to be manually moved by a user between a locked configuration, in which the lock prevents the drawer from being slidable out of the drawer chamber, and an unlocked configuration, in which the lock allows the drawer to slide at least partially out of the drawer chamber. Further, the movement can be vertical movement, or the movement can be horizontal movement.

For still another example, the insulated container can also include the drawer, the drawer can include a handle on a front surface thereof, and, with the drawer fully slid into the drawer chamber, the drawer chamber can be sealed closed.

For still another example, the horizontally-extending divider wall can be non-porous and rigid.

For another example, the upper housing, the lower housing, the horizontally-extending divider wall, the first vertically-extending divider wall, and the second vertically-extending divider wall can be rigid.

For yet another example, the insulated container can further include a second vertically-extending divider wall that extends vertically in the main chamber so as to divide the main chamber into first and second compartments. Further, the first vertically-extending divider wall and the second vertically-extending divider wall can be centered laterally; and/or the first vertically-extending divider wall can be below and vertically aligned with the second vertically-extending divider wall.

In another aspect, a method of manufacturing an insulated container is provided that in one embodiment includes forming an upper housing of an insulated container with injection molding of polypropylene such that the upper housing is a singular member that has a main chamber therein, an open upper end, sidewalls that each has a thickness in a range of about 2.5 to about 3.5 mm, and a bottom wall that has a thickness in a range of about 2.5 to about 3.5 mm and that includes a plurality of ribs. The main chamber is configured to receive a cooling agent that is configured to cool one or more first items removably contained in the main chamber. The method also includes forming a lower housing of the insulated container with injection molding of polypropylene such that the lower housing is a singular member that has a drawer chamber, sidewalls that each has a thickness in a range of about 2.5 to about 3.5 mm, and an open upper end. The drawer chamber is configured to slidably receive a drawer therein that is configured to removably contain one or more second items therein. The method also includes fixedly securing the upper and lower housings together such that the bottom wall of the upper housing defines a top wall of the drawer chamber and separates the main chamber from the drawer chamber.

The method can vary in any number of ways. For example, the method can also include disposing a first vertically-extending divider wall in the upper housing such that the main chamber is divided into first and second compartments, and the lower housing can define a second vertically-extending divider wall that extends a partial distance from back to front, and, with the upper and lower housings fixedly secured together, is below and vertically aligned with the first vertically-extending divider wall. Further, the first vertically-extending divider wall and the second vertically-extending divider wall can be centered laterally; and/or the method can also include forming the drawer with injection molding of polypropylene, and disposing the drawer in the drawer chamber such that first and second separate compartments of the drawer are disposed on either side of the second vertically-extending divider wall. Further, a space can be defined between an outer front face of the drawer and an interior wall of the drawer, and the method can also include filling the space with an insulating material; and/or, with the drawer fully disposed in the drawer chamber, a back-facing surface of the drawer can abut a front-facing surface of the second vertically-extending divider wall and the drawer chamber is sealed closed. Further, the insulating material can include polyurethane.

For yet another example, the method can also include forming the drawer with injection molding of polypropylene, the method can also include disposing the drawer in the drawer chamber such that, with the drawer fully disposed in the drawer chamber, the drawer chamber is sealed closed, and, with the upper and lower housings fixedly secured together, the drawer can be configured to be slid at least partially out of the drawer chamber without breaking a seal of the main chamber.

For still another example, the method can also include forming the drawer with injection molding of polypropylene, the method can also include disposing the drawer in the drawer chamber, the method can also include coupling a lock to the drawer, and the lock can be configured to be manually moved vertically between a locked configuration, in which the lock prevents the drawer from being slidable out of the drawer chamber, and an unlocked configuration, in which the lock allows the drawer to slide at least partially out of the drawer chamber.

For another example, the method can also include disposing the upper and lower housings in an outer housing such that at least one first space is defined between the outer housing and the upper housing and at least one second space is defined between the outer housing and the lower housing, and filling each of the at least one first space and the at least one second space with an insulating material. Further, the insulating material can include polyurethane; the method can also include forming the drawer with injection molding of polypropylene, at least one third space can be defined between an outer front face of the drawer and an interior wall of the outer housing, and the method can also include filling the at least one third space with the insulating material; and/or the outer housing can be formed of an ultraviolet (UV) resistant material or can have a UV-resistant coating thereon.

For yet another example, the method can also include coupling a lid to the upper housing such that the lid defines a top wall of the main chamber, and the lid can be configured to move between a closed configuration, in which the main chamber is sealed closed, and an open configuration, in which the main chamber is not sealed closed and the one or more first items removably contained in the main chamber are accessible to a user. Further, the method can also include forming the drawer with injection molding of polypropylene and disposing the drawer in the drawer chamber, and, with the lid in the closed configuration and with the upper and lower housing fixedly secured together, the drawer can be configured to be slid at least partially out of the drawer chamber without breaking a seal of the main chamber, and, with the drawer fully disposed in the drawer chamber, the drawer chamber can be sealed closed, and, with the drawer chamber sealed closed and with the upper and lower housing fixedly secured together, the lid can be configured to move from the closed configuration to the open configuration without breaking the seal of the drawer chamber. Further, coupling the lid to the upper housing can include hingedly attaching the lid to the upper housing, or the lid in the open configuration can be configured to be independent from the upper housing.

For still another example, the sidewalls of the upper housing can be substantially planar, the sidewalls of the lower housing can be substantially planar, and the bottom wall of the upper housing can be substantially planar and can extend substantially perpendicularly to the sidewalls of the upper housing and to the sidewalls of the lower housing.

For yet another example, the bottom wall of the upper housing can be non-porous.

For another example, the plurality of ribs can form a hexagonal pattern.

In another embodiment, a method of manufacturing an insulated container includes forming an upper housing of an insulated container with injection molding of polypropylene such that the upper housing is a singular member that has a main chamber therein, an open upper end, and a bottom wall that includes a plurality of ribs. The main chamber is configured to receive a cooling agent that is configured to cool one or more first items removably contained in the main chamber. The method also includes forming a lower housing of the insulated container with injection molding of polypropylene such that the lower housing is a singular member that has a drawer chamber therein that is configured to slidably receive a drawer therein that is configured to removably contain one or more second items therein, and an open upper end. The method also includes fixedly securing the upper and lower housings together such that the bottom wall of the upper housing defines a top wall of the drawer chamber and separates the main chamber from the drawer chamber, coupling a lid to the upper housing such that the lid defines a top wall of the main chamber, forming the drawer with injection molding of polypropylene, and disposing the drawer in the drawer chamber such that, with the drawer fully disposed in the drawer chamber, the drawer chamber is sealed closed. The lid is configured to move between a closed configuration, in which the main chamber is sealed closed, and an open configuration, in which the main chamber is not sealed closed and the one or more first items removably contained in the main chamber are accessible to a user. With the upper and lower housing fixedly secured together, the drawer is configured to be slid at least partially out of the drawer chamber without breaking the seal of the main chamber. With the drawer chamber sealed closed and with the upper and lower housings fixedly secured together, the lid is configured to move from the closed configuration to the open configuration without breaking the seal of the drawer chamber.

The method can vary in any number of ways. For example, the bottom wall can be non-porous.

For another example, coupling the lid to the upper housing can include hingedly attaching the lid to the upper housing.

For yet another example, the lid in the open configuration can be configured to be independent from the upper housing.

For still another example, the method can also include disposing the upper and lower housings in an outer housing such that at least one first space is defined between the outer housing and the upper housing and at least one second space is defined between the outer housing and the lower housing, and filling each of the at least one first space and the at least one second space with an insulating material. Further, the insulating material can include polyurethane; and/or at least one third space can be defined between an outer front face of the drawer and an interior wall of the outer housing, and the method can also include filling the at least one third space with the insulating material.

For another example, the bottom wall can have a thickness in a range of about 2.5 to about 3.5 mm. Further, the upper housing can include sidewalls that can each have a thickness in a range of about 2.5 to about 3.5 mm.

For yet another example, the plurality of ribs can form a hexagonal pattern.

In another aspect, an apparatus is provided that is formed according to a method of manufacturing an insulated container, for example any of the methods above.

### BRIEF DESCRIPTION OF DRAWINGS

This disclosure will be more fully understood from the following detailed description taken in conjunction with the accompanying drawings, in which:

FIG. 1 is a perspective view of one embodiment of an insulated container;

FIG. 2 is another perspective view of the insulated container of FIG. 1;

FIG. 3 is yet another perspective view of the insulated container of FIG. 1;

FIG. 4 is a perspective cross-sectional view of the insulated container of FIG. 1;

FIG. 5 is a back side cross-sectional view of the insulated container of FIG. 1;

FIG. 6 is another perspective cross-sectional view of the insulated container of FIG. 1;

FIG. 7 is a yet another perspective cross-sectional view of the insulated container of FIG. 1;

FIG. 7A is a partial side cross-sectional view of the insulated container of FIG. 1;

FIG. 8 is still another perspective cross-sectional view of the insulated container of FIG. 1;

FIG. 9 is a top side cross-sectional view of the insulated container of FIG. 1;

FIG. 10 is another perspective cross-sectional view of the insulated container of FIG. 1;

FIG. 11 is a yet another perspective cross-sectional view of the insulated container of FIG. 1;

FIG. 12 is another top side cross-sectional view of the insulated container of FIG. 1;

FIG. 13 is another perspective cross-sectional view of the insulated container of FIG. 1;

FIG. 14 is another top side cross-sectional view of the insulated container of FIG. 1;

FIG. 15 is another perspective view of the insulated container of FIG. 1;

FIG. 16 is a perspective view of another embodiment of an insulated container;

FIG. 17 is another perspective view of the insulated container of FIG. 16;

FIG. 18 is yet another perspective view of the insulated container of FIG. 16;

FIG. 19 is a perspective view of the insulated container of FIG. 16 with a lid open and a drawer open;

FIG. 20 is a perspective view of another embodiment of an insulated container;

FIG. 21 is a perspective view of the insulated container of FIG. 20 with a lid open and a drawer open;

FIG. 22 is a schematic view of a drawer lock of the insulated container of FIG. 20 with the drawer lock in a locked configuration;

FIG. 23 is a schematic view of the drawer lock of FIG. 22 with the drawer lock in an unlocked configuration;

FIG. 24 is a schematic view of a lid lock of the insulated container of FIG. 20 with the lid lock in a locked configuration;

FIG. 25 is a schematic view of the lid lock of FIG. 24 with the lid lock in an unlocked configuration; and

FIG. 26 is a perspective view of another embodiment of an insulated container.

### DETAILED DESCRIPTION

Certain embodiments will now be described to provide an overall understanding of the principles of the structure, function, manufacture, and use of the devices, systems, and methods disclosed herein. One or more examples of these embodiments are illustrated in the accompanying drawings. Those skilled in the art will understand that the devices, systems, and methods specifically described herein and illustrated in the accompanying drawings are non-limiting embodiments and that the scope of the present invention is defined solely by the claims. The features illustrated or described in connection with one exemplary embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape.

Various systems, devices, and methods for insulated containers with a drawer are provided. In general, an insulated container, such as a portable cooler, includes a drawer. The insulated container includes a main chamber and includes a drawer chamber that is separate from the main chamber and is configured to movably receive the drawer therein. The main chamber is configured to hold a cooling agent that is configured to cool any items in the main chamber and also any items in the drawer. The item(s) in the drawer may thus be separated from the cooling agent and not become wet from moisture in the main chamber, e.g., from the cooling agent melting or defrosting. Additionally, the main and drawer chambers being separate from one another allows one of the main and drawer chambers to be opened, e.g., to access item(s) contained therein, without breaking a seal of the unopened one of the drawer and main chambers. A temperature within the unopened one of the drawer and main chambers may thus be prevented from decreasing so as to help maintain effective cooling of the item(s) contained therein.

In an exemplary embodiment, an insulated container is manufactured using injection molding. Using injection molding to manufacture the insulated container may allow for finer details and tolerance control than other manufacturing methods, such as rotomolding. Using injection molding to manufacture the insulated container may allow for individual components of the insulated container to be formed separately. Forming components separately may improve overall structural integrity of each individual component and thus overall structural integrity of the fully assembled insulated container. Forming components separately may improve cooling performance since a singular member does not have seams, joints, or other connection areas that would exist if the singular member was instead formed of two or more parts connected together. Forming components separately may help prevent leaks since a singular member does not have seams, joints, or other connection areas where leaks are most likely to develop.

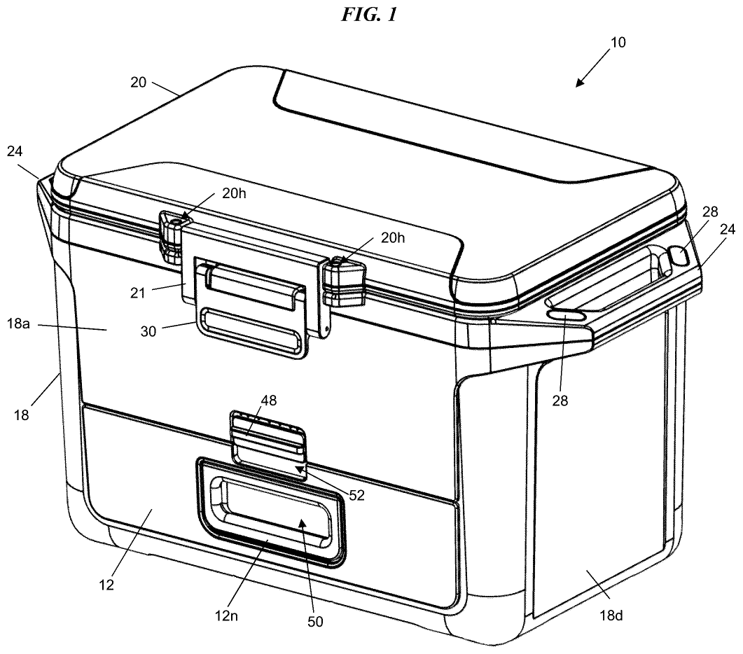

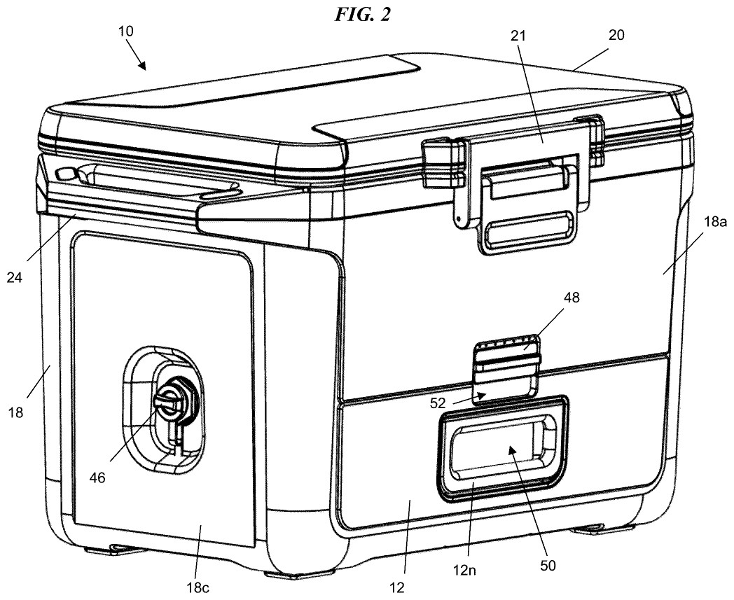

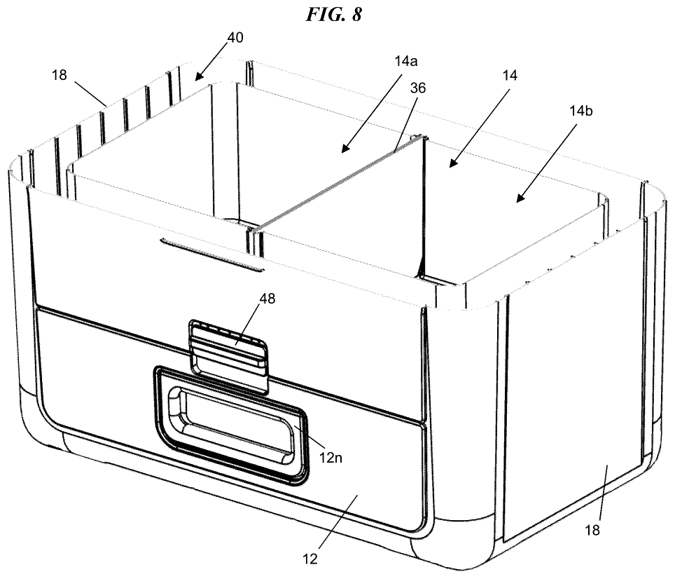

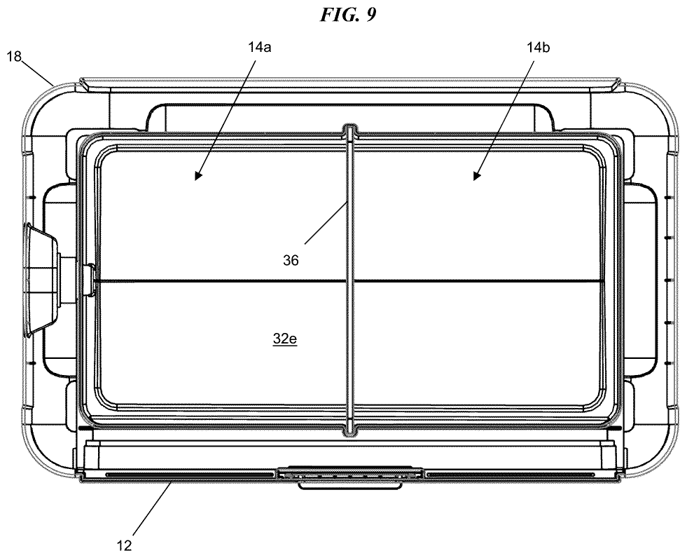

FIGS. 1-15 illustrate one embodiment of an insulated container 10 that includes a drawer 12. The insulated container 10 in this illustrated embodiment is a portable cooler. The insulated container 10 is configured to hold therein a cooling agent, such as ice or one or more reusable cooler packs, configured to cool one or more items, such as food, beverages, and medicine, also held in the insulated container 10.

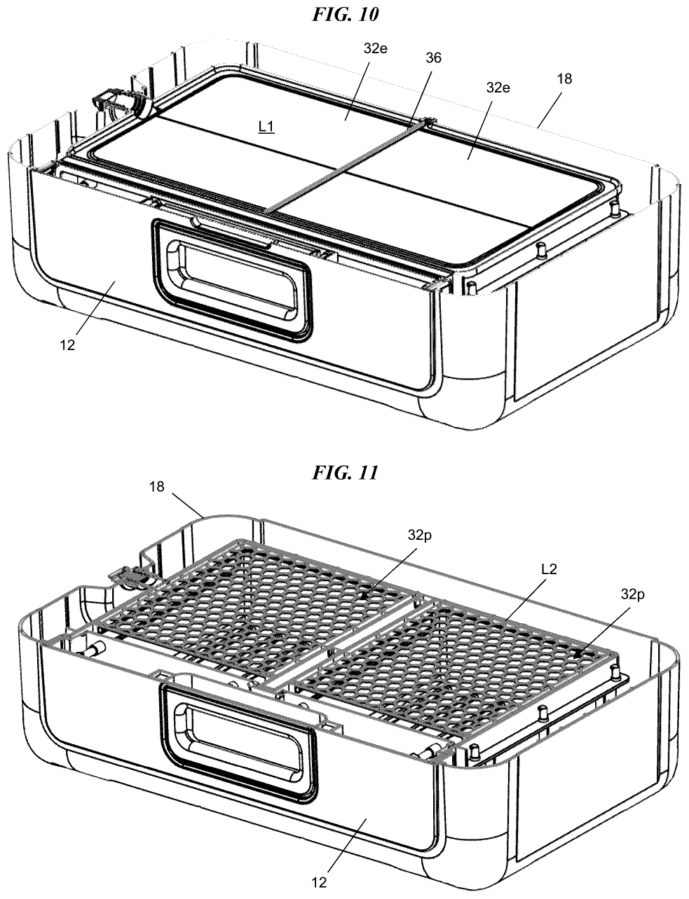

As discussed further below, the insulated container 10 includes a main chamber 14 (see for example FIG. 8) configured to hold the cooling agent therein and includes a drawer chamber 16 that is configured to movably receive the drawer 12 therein (see for example FIG. 13). The drawer chamber 16 is isolated from the main chamber 14 such that the drawer 12 received in the drawer chamber 16 is also isolated from the main chamber 14. Thus, as the cooling agent defrosts or melts, the cooling agent itself and/or condensation from the cooling agent cannot wet the item(s) in the drawer 12. Similarly, a beverage or other item that accidentally spills or leaks in the main chamber 14 cannot wet or otherwise damage any items in the drawer 12, and vice versa with a beverage or other item that accidentally spills or leaks in the drawer 12 cannot wet or otherwise damage any items in the main chamber 12.

The drawer chamber 16, and thus the drawer 12 received therein, is located vertically below the main chamber 14, e.g., the drawer chamber 16 and the drawer 12 received therein are closer to a bottom of the insulated container 10 than the main chamber 14. Because gravity tends to draw the cooling agent in the main chamber 14 vertically down, the cooling agent is urged to settle as close as possible to the drawer chamber 16, and thus the drawer 12 received therein.

Opening one of the main chamber 14 and the drawer chamber 16 causes a temperature inside the open chamber to increase due to ambient outside temperature and thus may reduce effectiveness of the cooling agent's cooling of item(s) contained in the open chamber. The drawer chamber 16 and the main chamber 14 being isolated from each other allows one of the main chamber 14 and the drawer chamber 16 to be opened, e.g., to access item(s) contained therein, without breaking a seal of the unopened one of the drawer chamber 16 and the main chamber 14. A temperature within the unopened one of the drawer chamber 16 and the main chamber 14 may thus be prevented from decreasing so as to help maintain effective cooling of the item(s) contained therein. Further, if the drawer chamber 16 is the one of the main and drawer chambers 14, 16 that is opened, the cooling agent in the main chamber 14 will not be exposed to ambient outside air such that the cooling agent's melting or defrosting is not accelerated due to exposure to ambient outside temperature. In other words, opening the drawer 12 to access item(s) therein will not encourage melting or defrosting of the cooling agent in the main chamber 14 like opening of the main chamber 14 does and may therefore prolong effective cooling provided by the cooling agent.

A user may choose to place a cooling agent in the drawer 12 in addition to or instead of in the main chamber 14. However, a cooling agent does not need to be placed in the drawer 12 to cool any items in the drawer 12 because the insulated container 10 is configured to allow the cooling agent in the main chamber 14 to cool the item(s) in the drawer 12, as discussed further below.

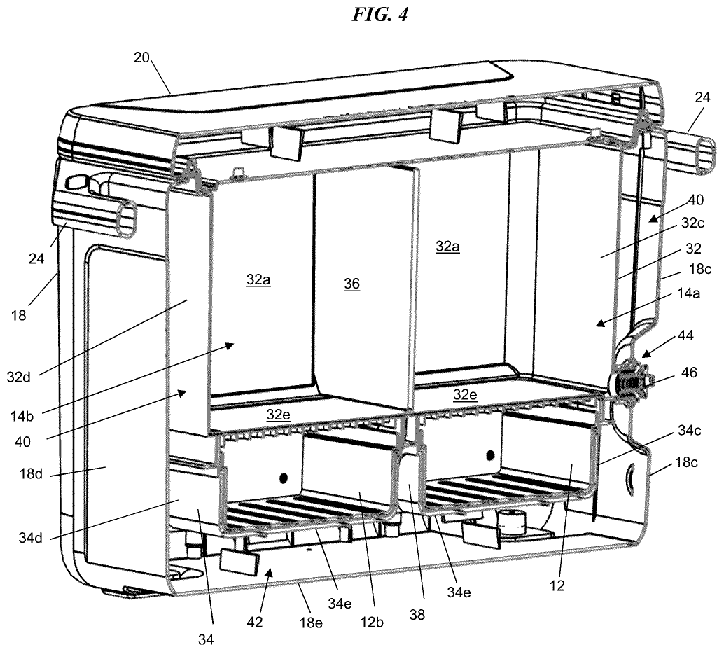

The insulated container 10 includes an outer housing 18 and a lid 20 movably coupled to the outer housing 18. The lid 20, e.g., a bottom outer surface of the lid 20, defines a top wall of the main chamber 14 (see for example FIG. 4-7). The lid 20 is configured to move between a closed configuration, in which the main chamber 14 is sealed closed, and an open configuration, in which the main chamber 14 is not sealed closed and the cooling agent and any item(s) removably contained in the main chamber 14 are accessible to a user. In other words, with the lid 20 in the open configuration, a top of the main chamber 14 is open and the main chamber 14 is exposed to ambient outside air. The lid 20 is shown in the closed configuration in FIGS. 1-7 and 15.

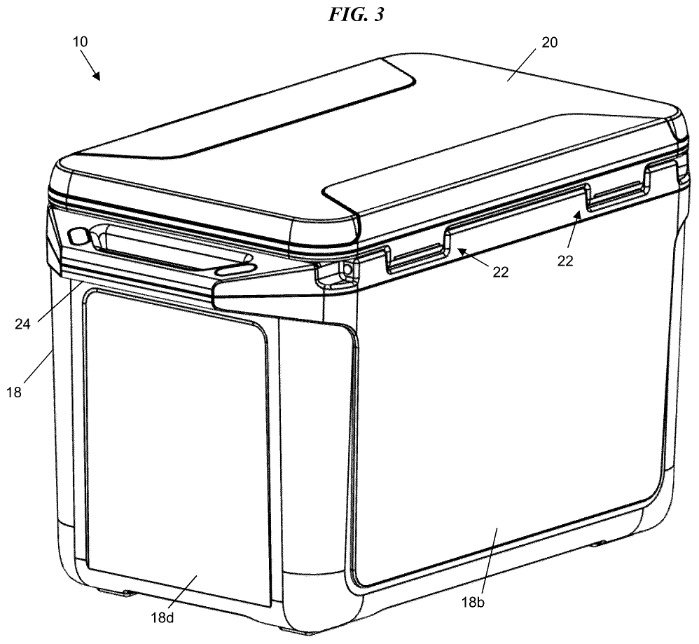

The lid 20 is hingedly and non-removably coupled to the outer housing 18 via a hinge 22, as shown in FIG. 3 in which the hinge 22 includes two hinges, although another number of hinges (e.g., one, three, etc.) can be used. The hinge 22 is configured to prevent the lid 20 from being fully removed from the outer housing 18, which may help prevent loss of the lid 20, may help shield the open main chamber 14 from direct sunlight or other direct heat, and/or may help remind a user to replace the lid 20 when access to the main chamber 14 is no longer needed. In other embodiments, the lid 20 can be non-removably coupled to the lid 20 using another attachment mechanism, such as a flexible tether. In still other embodiments, the lid 20 can be removably attached to the outer housing 18 so as to allow the lid 20 to be fully removed from the outer housing 18.

The insulated container 10 includes a lid lock 21 configured to lock the lid 20 in the closed configuration. The lid lock 21 is configured to move between, e.g., be manually moved by a user between, a locked configuration, in which the lid 20 is locked in the closed configuration, and an unlocked configuration, in which the lid 20 is allowed to be moved, e.g., be manually moved by a user, from the closed configuration to the open configuration. The lid 20 can thus be prevented from opening accidentally, which may help prevent any contents of the main chamber 14 from spilling out (e.g., during transit of the insulated container 10, if the insulated container 10 is dropped accidentally, etc.) and may help prevent the main chamber 14 from accidentally being unsealed and thus increasing in temperature. FIGS. 1, 2, and 6 show the lid lock 21 in the locked configuration.

The lid lock 21 in this illustrated embodiment includes a movable latch but can have other configurations. A bottom of the lid lock 21 in this illustrated embodiment is pivotally attached to the outer housing 18. The lid lock 21 is configured to move between the locked and unlocked configurations by pivoting relative to the outer housing 18 and to the lid 20. A top of the lid lock 21 is configured to releasably engage the lid 20. In the locked configuration, the top of the lid lock 21 engages the lid 20. In the unlocked configuration, the top of the lid lock 21 does not engage the lid 20.

The lid 20 in this illustrated embodiment includes a pair of lock holes 20h corresponding to a pair of lock holes formed in the outer housing 208 (the outer housing's lock holes are obscured in the figures). With the lid 20 closed, the lid's lock holes 20h are configured to align with the outer housing's lock holes. The aligned lid lock holes 20h and outer housing lock holes are configured to receive therethrough a padlock or other locking mechanism (e.g., a zip tie, a rope, etc.) to provide a backup lock of the lid 20 in the closed configuration. The lid 20 and the outer housing 18 each include two lock holes in this illustrated embodiment but can include another number (e.g., one, three, etc.) of lock holes.

The outer housing 18 defines opposed side handles 24 of the insulated container 10. The opposed side handles 24 are configured to be held to facilitate portability of the insulated container 10. The insulated container 10 can include another number of side handles 24 and/or have handle(s) at other locations to facilitate portability of the insulated container 10. The opposed side handles 24 are integrally formed with the outer housing 18 in this illustrated embodiment. In other embodiments the opposed side handles 24 can be separate members attached to the outer housing 18.

The opposed side handles 24 in this illustrated embodiment each include one or more holes 26 formed therein, as shown in FIG. 15. Each of the handles 24 includes four openings 26 in this illustrated embodiment but can include another number of openings (e.g., one, two, etc.). In other embodiments, the openings 26 are omitted. The openings 26 are configured to receive a strap, rope, or other member therein configured to facilitate user movement of the insulated container 10, e.g., by carrying, pulling, etc. The strap, rope, or other member can be non-removably or removably received in the openings 26. In some embodiments, the insulated container 10 can include at least one wheel, e.g., two wheels at a bottom of the insulated container 10 on either the left or right side thereof, four wheels at a bottom of the insulated container 10 in four corners thereof, etc., configured to allow for rolling movement of the insulated container 10. A strap, rope, or other member in the openings 26 may help a user achieve such rolling movement. In this illustrated embodiment, the openings 26 are each closed with a cover 28 (see FIG. 1) releasably coupled to the handles 24. In some embodiments, the cover 28 is omitted.

The insulated container 10 in this illustrated embodiment includes a front handle 30. The front handle 30 is configured to facilitate portability of the insulated container 10, e.g., by carrying, pulling, etc. The front handle 30 in this illustrated embodiment is pivotally attached to the outer housing 18, which allows the front handle 30 to be positioned flush and unobtrusively against the outer housing 18 when not in use, as shown in FIGS. 1, 2, and 6. The insulated container 10 can include another number of front handles 30 and/or have handle(s) at other locations to facilitate portability of the insulated container 10. The front handle 30 is a separate member from the outer housing 18, but in some embodiments, the front handle 30 is formed integrally with the outer housing 18 similar to the opposed side handles 24 shown in FIGS. 1-5 and 15.

The outer housing 18 has a front wall 18a, a back wall 18b, a left side wall 18c, a right side wall 18d, and a bottom wall 18e, as shown in FIGS. 1-4. The front wall 18a, the back wall 18b, the left side wall 18c, the right side wall 18d, and the bottom wall 18e define an interior cavity of the outer housing 18. The outer housing 18, and thus the interior cavity, has an open top configured to be selectively covered by the lid 20. Each of the front wall 18a, the back wall 18b, the left side wall 18c, and the right side wall 18d of the outer housing 18 extends vertically. The bottom wall 18e of the outer housing 18 extends horizontally. In an exemplary embodiment, each of the front wall 18a, the back wall 18b, the left side wall 18c, the right side wall 18d, and the bottom wall 18e have a thickness in a range of about 2.5 to about 3.5 mm.

The insulated container 10 includes an upper housing 32 and a lower housing 34 each configured to be disposed within the outer housing 18 such that the upper and lower housings 32, 34 are contained within the outer housing 18. The upper housing 32 has the main chamber 14 therein. The lower housing 34 has the drawer chamber 16 therein. The upper and lower housings 32, 34 are separate housings from one another, which facilitates the independence of the main and drawer chambers 14, 16 discussed herein. The upper and lower housings 32, 34 being separate housings from one another also allows the upper and lower housings 32, 34 to be separately molded, as discussed further below.

The upper housing 32 has a front wall 32a, a back wall 32b, a left side wall 32c, a right side wall 32d, and a bottom wall 32e. The front wall 32a, the back wall 32b, the left side wall 32c, the right side wall 32d, and the bottom wall 32e define the main chamber 14. The upper housing 32, and thus the main chamber 14, has an open top configured to be selectively covered by the lid 20. Each of the front wall 32a, the back wall 32b, the left side wall 32c, and the right side wall 32d of the upper housing 32 extends vertically and is substantially planar. A person skilled in the art will appreciate that an element may not be precisely planar but nevertheless considered to be substantially planar for any number of reasons, such as manufacturing tolerances or sensitivity of measurement equipment. The bottom wall 32e of the upper housing 32 extends horizontally and is substantially planar. In an exemplary embodiment, each of the front wall 32a, the back wall 32b, the left side wall 32c, and the right side wall 32d have a thickness in a range of about 2.5 to about 3.5 mm. A person skilled in the art will appreciate that a value may not be precisely at a certain value but nevertheless considered to be about that value for any number of reasons, such as manufacturing tolerances or sensitivity of measurement equipment.

In an exemplary embodiment, the upper housing 32 (e.g., the front wall 32a, the back wall 32b, the left side wall 32c, the right side wall 32d, and the bottom wall 32e) is formed of polypropylene. In an exemplary embodiment, the upper housing 32 is rigid, such as when formed of polypropylene, which may help provide structural integrity to the insulated container 10.

The main chamber 14 defined by the upper housing 32 is a single cavity. The insulated container 10 includes a first divider wall 36 disposed in the main chamber 14 that divides the single cavity of the main chamber 14 into first and second compartments 14a, 14b. Dividing the main chamber 14 into multiple compartments may improve user experience by allowing item(s) in the main chamber 14 to be more easily located. The first divider wall 36 extends vertically and is substantially planar. The first divider wall 36 is centered laterally in the main chamber 14 so as to divide the main chamber 14 substantially in half such that each of the first and second compartments 14a, 14b are substantially the same size.

The first divider wall 36 can either be removably disposed in the upper housing 32 or can be non-removably disposed in the upper housing 32. The first divider wall 36 is a separate member from the upper housing 32 in this illustrated embodiment, which may facilitate molding of the upper housing 32, as discussed further below. In some embodiments, the first divider wall 36 is formed integrally with the upper housing 32.

The lower housing 34 has a back wall 34b, a left side wall 34c, a right side wall 34d, and a bottom wall 34e. The back wall 34b, the left side wall 34c, the right side wall 34d, and the bottom wall 34e define the drawer chamber 16. Each of the back wall 34b, the left side wall 34c, and the right side wall 34d of the lower housing 34 extends vertically and is substantially planar. The bottom wall 34e of the lower housing 34 extends horizontally and is substantially planar. In an exemplary embodiment, each of the back wall 34b, the left side wall 34c, the right side wall 34d, and the bottom wall 34e have a thickness in a range of about 2.5 to about 3.5 mm.

In an exemplary embodiment, the lower housing 34 (e.g., the back wall 34b, the left side wall 34c, the right side wall 34d, and the bottom wall 34e) is formed of polypropylene. In an exemplary embodiment, the lower housing 34 is rigid, such as when formed of polypropylene, which may help provide structural integrity to the insulated container 10.

The lower housing 34 has an open top. With the lower housing 34 attached to the upper housing 32, the bottom wall 32e of the upper housing 32 defines a top of the drawer chamber 16, as shown in FIGS. 4-7. The bottom wall 32e is non-porous such that liquid or other material cannot enter the drawer chamber 16 (or the drawer 12 therein) from the main chamber 14 through the bottom wall 32e. The bottom wall 32e is configured to allow the cooling agent in the main chamber 14 to cool the one or more items contained in the drawer chamber 16. e.g., in the drawer 12 received in the drawer chamber 16. The bottom wall 32e being formed of polypropylene and having a thickness in a range of about 2.5 to about 3.5 mm allows the bottom wall 32e to be thick enough to provide durability and thin enough to provide effective cooling therethrough from the main chamber 14 to the drawer chamber 16, e.g., to allow a typical cooling agent in the main chamber 14 to cool the drawer chamber 16 (and thus the drawer 12 therein) to below about 40° F.

The bottom wall 32e can, as in this illustrated embodiment, be configured to be strong enough that the bottom wall 32e resists deflecting downward into the drawer chamber 16, even under the weight of the cooling agent and items located in the main chamber 14. In some embodiments, the bottom wall 32e can, as in this illustrated embodiment, be configured to be strong enough, in combination with the load-bearing strength of second divider wall 38, that the bottom wall 32e resists deflecting downward into the drawer chamber 16, even under the weight of the cooling agent and items located in the main chamber 14. Being formed from a rigid material, such as when formed of polypropylene, is configured to help provide strength to the bottom wall 32e. Additionally, with the bottom wall 32e being formed of polypropylene, instead of a metal, the conductive properties of polypropylene are configured to, if the drawer 12 is opened, help prevent the bottom wall 32e from rapidly heating from warm or hot air in the drawer chamber 16 and/or the drawer 12 and conducting warm energy to the main chamber 14 from the drawer chamber 16. The bottom wall 32e being formed of polypropylene may also prevent the bottom wall 32e from rapidly heating from warm or hot air in the main chamber 14 is the lid 20 is opened, and thus help prevent conducting warm energy to the drawer chamber 16 from the main chamber 14, but the bottom wall 32e is less susceptible to rapid heating if the lid 20 is opened than if the drawer 12 is opened because of the cooling agent located in the main chamber 14 and because gravity tends to settle the cooling agent on or toward the bottom wall 32e.

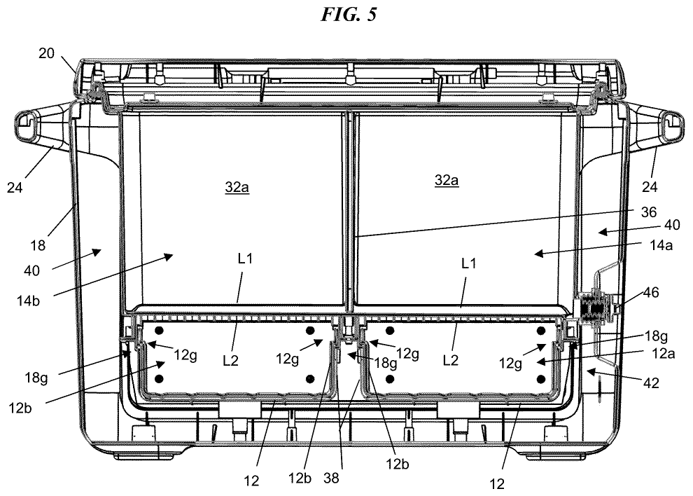

As in this illustrated embodiment, the bottom wall 32e can include a plurality of layers. The layers in this illustrated embodiment includes a first layer L1 and a second layer L2 disposed vertically below the first layer L1, as shown in FIGS. 5-7. The first layer L1 defines a top of the bottom wall 32e and faces the main chamber 14. The second layer L2 defines a bottom of the bottom wall 32e and faces the drawer chamber 16 (and thus also the drawer 12 received in the drawer chamber 16). The first layer L1 of the bottom wall 32e is a non-porous member. The second layer L2 of the bottom wall 32e is a porous member having a plurality of pores 32p formed therein, as shown in FIGS. 11 and 12. Because the bottom wall 32e is non-porous by including the non-porous first layer L1, liquid and other matter in the main chamber 14 cannot pass into the drawer chamber 16 (or the drawer 12 received in the drawer chamber 16) through the bottom wall 32e. The non-porous first layer L1 being located vertically above the porous second layer L2 helps prevent any liquid or other matter in the main chamber 14 from collecting in or passing through the pores 32p. In other words, the non-porous first layer L1 acts as a barrier to the porous second layer L2.

Each of the pores 32p in this illustrated embodiment has a hexagonal shape. (Some of the pores 32p along edges of the second layer L2 may have truncated hexagonal shapes depending on a size and shape of the hexagonal shapes and a size and shape of the bottom wall 32e.) The bottom wall 32e thus includes a plurality of hexagonal ribs that define a hexagonal rib structure in a honeycomb pattern, as shown in FIGS. 11 and 12. The hexagonal rib structure may increase durability of the bottom layer 32e and reduce vertical deflecting of the bottom wall 32e downward under a load of the cooling agent and the item(s) in the main chamber 14 without having to increase overall thickness of the bottom wall 32e above about 3.5 mm, thereby reducing overall weight of the insulated container 10 and overall cost of the insulated container 10. Although the pores 32p each have a hexagonal shape in this illustrated embodiment, other shapes may be used, e.g., rectangular, pentagonal, octagonal, etc. The hexagonal shape can have a variety of dimensions. For example, as in this illustrated embodiment, the dimension of each hexagonal shape can be about 14 mm across, about 1 mm wide, and about 5.95 mm high.

Bottom wall deflection testing, under a modelled force of 224 N applied to a bottom wall from within a main chamber (defined by an upper housing formed of polypropylene), has shown that the bottom wall deflects vertically downward less when the bottom wall includes a hexagonal rib structure as a second layer similar to the second layer L2 of the bottom wall 32e than when the bottom wall does not include a hexagonal rib structure.

The lower housing 34, and thus the drawer chamber 16, has an open front in which the drawer 12 is configured to be received. In some embodiments, the drawer 12 is removably received in the drawer chamber 16 such that the drawer 12 can be removed from the drawer chamber 12, which may facilitate cleaning of the drawer 12. In some embodiments, the drawer is non-removably received in the drawer chamber 16, which may help prevent loss of and/or damage to the drawer 12.

The drawer chamber 16 defined by the lower housing 34 is a single cavity configured to receive the drawer 12 therein. The drawer 12 is configured to move between a closed configuration, in which the drawer chamber 16 is sealed closed, and an open configuration, in which the drawer chamber 16 is not sealed closed and any item(s) removably contained in the drawer 12 are accessible to a user. The drawer 12 in this illustrated embodiment includes first and second compartments 12a, 12b that are separate from one another. The drawer 12 having multiple compartments may improve user experience by allowing item(s) in the drawer 12 to be more easily located and/or may help lessen shifting of item(s) in the drawer 12 during transit of the insulated container 10. In other embodiments, the drawer 12 can have a single compartment or can have more than two compartments.

In an exemplary embodiment, the drawer 12 is formed of polypropylene. In an exemplary embodiment, the drawer 12 is rigid, such as when formed of polypropylene, which may help provide structural integrity to the drawer 12 and to the insulated container 10 with the drawer 12 coupled thereto.

The back wall 34b of the lower housing 34 is not a planar member extending vertically in a single plane like each of the left side wall 34c, the right side wall 34d, and the bottom wall 34e of the lower housing 34. Instead, the back wall 34b of the lower housing 34 has a U-shaped vertical extension formed therein that defines a second divider wall 38 that extends vertically, as shown in FIGS. 4, 5, 13, and 14. The second divider wall 38 is centered laterally. The second divider wall 38 is located below and can, as in this illustrated embodiments, be vertically aligned with the first divider wall 36. The second divider wall 38 being vertically aligned with the first divider wall 36 may help provide durability and strength to the insulated container 10, for example, by providing load-bearing support to the bottom wall 32e.

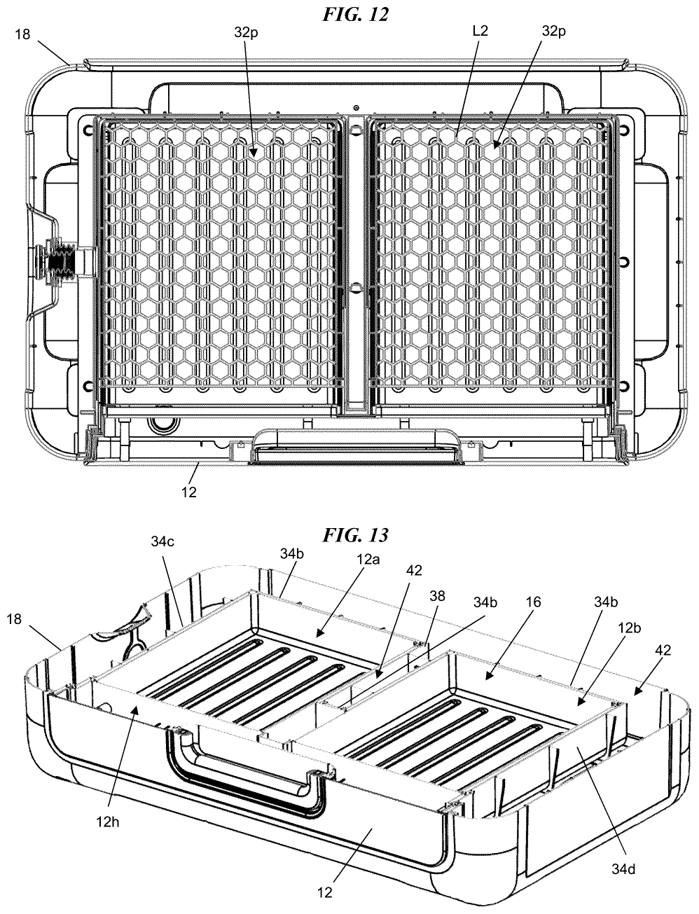

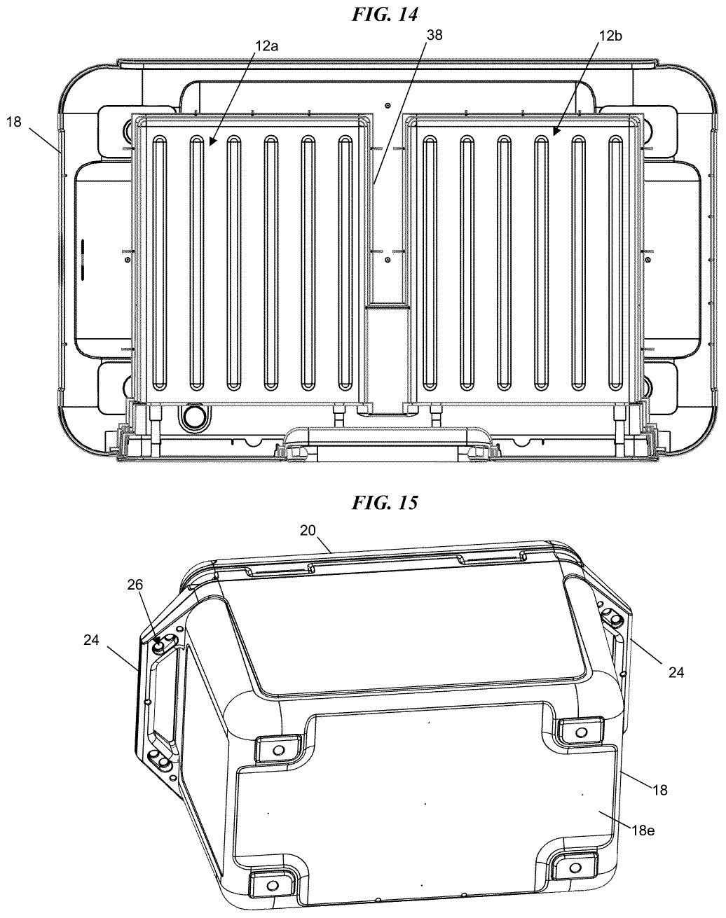

The first divider wall 36 extends a complete distance from the back wall 32b of the upper housing 32 to the front wall 32a of the upper housing 32. Conversely, in this illustrated embodiment, the second divider wall 38 extends a partial distance from back to front, as shown in FIGS. 13 and 14. In an exemplary embodiment, the partial distance is about a half distance from back to front.

The bottom wall deflection testing described above has shown that the second divider wall extending a complete distance from back to front, a so-called “full divider,” provides very little additional benefit in terms of deflection. Thus, the second divider wall 38 extending about a half distance from back to front, a so-called “half divider,” may provide reduced deflection as compared to no second divider wall being present while allowing for less material to be used in formed the lower housing 34, and thus allowing for a lower cost of the lower housing 34.

To account for the presence of the second divider wall 38, a back wall 12b of the drawer 12 is not a planar member extending vertically in a single plane like each of the drawer's left side wall 12c, the right side wall 12d, and the bottom wall 12e. Instead, the back wall 12b of the drawer 12 has a U-shaped vertical extension formed therein having a shape and size corresponding to the second divider wall 38, as shown in FIGS. 5, 6, 13, and 14. With the drawer 12 fully slid into the drawer chamber 16, a back-facing surface of the drawer 12 defined by the back wall 12b is configured to abut a front-facing surface of the second vertical substantially planar divider wall 38. FIGS. 13 and 14 show the abutting of these surfaces.

As mentioned above, the upper and lower housings 32, 34 are configured to be non-removably attached to one another and to be contained within the outer housing 18. With the upper and lower housings 32, 34 in the outer housing 18, a first space 40 is defined between the outer housing 18 and the upper housing 32, e.g., between an interior surface of the outer housing 18 and an exterior surface of the upper housing 32, and a second space 42 is defined between outer housing 18 and the lower housing 34, e.g., between the interior space of the outer housing 18 and an exterior surface of the lower housing 34. As shown in FIGS. 4-6, the first and second spaces 40, 42 are continuous with one another since the upper and lower housings 32, 34 are attached to one another.

The first space 40 is configured to be filled with an insulating material configured to insulate the main chamber 14, and the second space 42 is configured to be filled with an insulating material configured to insulate the drawer chamber 16 and thus also the drawer 12 received therein. In an exemplary embodiment, the insulating material is the same throughout the insulating container 10, e.g., polyurethane foam or other insulating material.

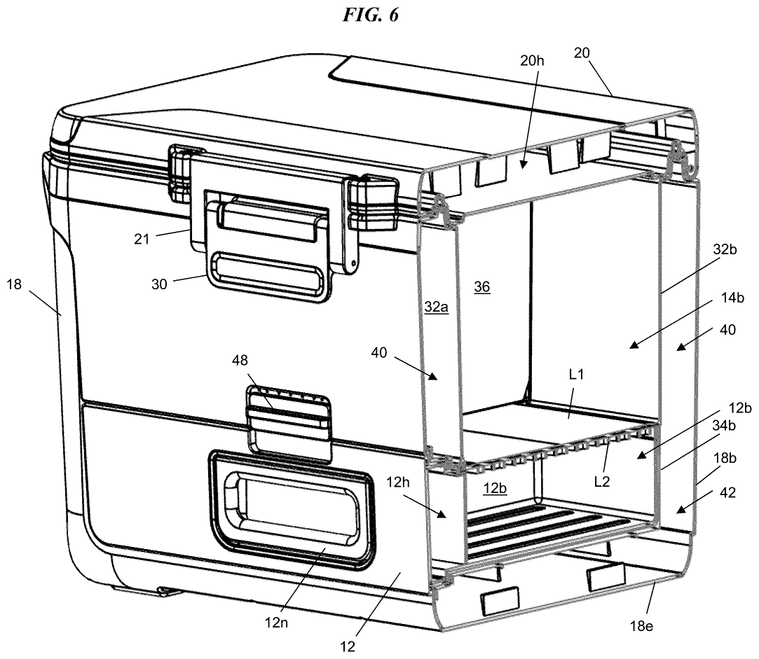

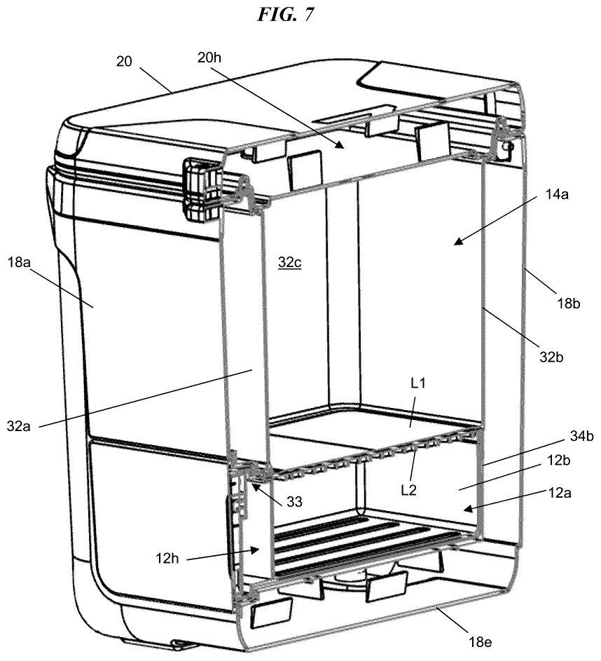

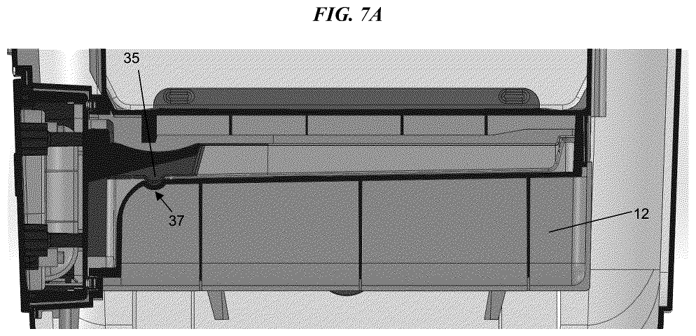

The first space 40 extends around the four vertically-extending sides of the upper housing 32 (the front wall 32a, the back wall 32b, the left side wall 32c, and the right side wall 32d). The lid 20 has a hollow interior 20h, as shown in FIGS. 6 and 7, that is configured to be filled with the insulating material. The main chamber 14 is thus configured to be insulated around its perimeter by the insulating material in the first space 40 and along its top by the insulating material in the lid's hollow interior 20h.

The second space 42 extends around the three vertically-extending sides of the lower housing 34 (the back wall 34b, the left side wall 34c, and the right side wall 32d) and below the bottom wall 34e of the lower housing 34. The drawer 12 has a hollow front space 12h, as shown in FIGS. 6, 7, and 13, that is configured to be filled with the insulating material. The drawer chamber 16, and therefore the drawer 12 received in the drawer chamber 16, is thus configured to be insulated along its back and left and right sides by the insulating material in the second space 42 and along its front by the insulating material in the drawer's hollow interior 12h.

The insulated container 10 includes a drain 44 configured to facilitate draining of liquid (e.g., water from melted ice, spilled beverage, etc.) from the main chamber 14. As shown in FIG. 4, the drain 44 is in fluid communication with the main chamber 14. The drain 44 is configured to be selectively opened and closed by a user, e.g., by removing a plug 46 sealing the drain 44 closed. With the drain 44 closed, liquid in the main chamber cannot exit out of the main chamber 14 through the drain 44 With the drain 44 open, liquid can exit out of the main chamber 14, and thus out of the insulated container 10, through the drain 44. The drain 44 is formed in a left side of the insulated container 10 in this illustrated embodiment, e.g., extends through the left side wall 18c of the outer housing 18, but can be located elsewhere. Also, the insulated container 10 includes only one drain 44 in this illustrated embodiment but can include multiple drains. In some embodiments, the drain 44 is omitted.

The insulated container 10 includes a drawer lock 48 configured to lock the drawer 12 in the closed configuration. The drawer lock 48 is configured to move between, e.g., be manually moved by a user between, a locked configuration, in which the drawer 12 is locked in the closed configuration, and an unlocked configuration, in which the drawer 12 is allowed to be moved, e.g., be manually moved by a user, from the closed configuration to the open configuration. The drawer 12 can thus be prevented from opening accidentally, which may help prevent any contents of the drawer 12 from spilling out (e.g., during transit of the insulated container 10, if the insulated container 10 is dropped accidentally, etc.) and may help prevent the drawer 12 from accidentally being unsealed and thus increasing in temperature. FIGS. 1, 2, 6, and 8 show the drawer lock 48 in the unlocked configuration.

The drawer 12 can, as in this illustrated embodiment include a handle 12n configured to be handheld by a user to facilitate opening and closing of the drawer 12. The handle 12n in this illustrated embodiment includes a ring pivotally coupled at a top thereof to the outer housing 18. Under the force of gravity the handle 12n is urged to be seated in a first depression 50 formed in a front exterior surface of the drawer 12. The handle 12n being seated in the first depression 50 can help keep the handle 12n out of the way when not in use. The handle 12n can have configurations other than a ring, such as a depression formed in the front exterior surface of the drawer 12 and defining a hand or finger hold therein, a knob, etc.

The drawer lock 48 is configured to move vertically between the unlocked and locked configurations. The drawer lock 48 in the unlocked configuration is located vertically above the drawer lock in the locked configuration. In the locked configuration, the drawer lock 48 is seated at least partially in a second depression 52 formed in the front exterior surface of the drawer 12. In the unlocked configuration, the drawer lock 48 is not seated in the second depression 52.

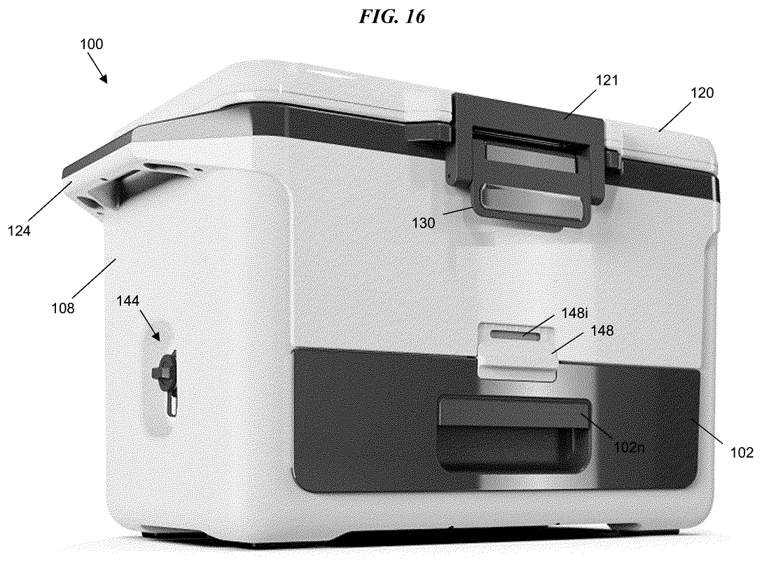

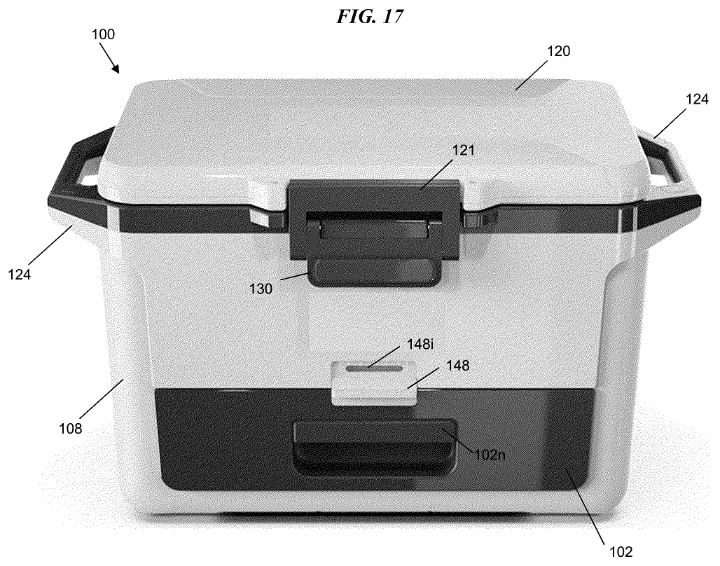

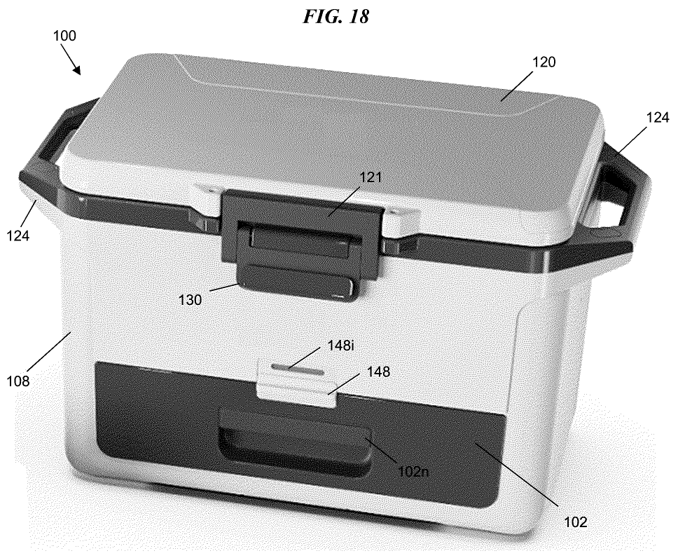

FIGS. 16-19 illustrate another embodiment of an insulated container 100 that includes a drawer 102. The insulated container 100 in this illustrated embodiment is generally configured and used similar to the insulated container 10 of FIGS. 1-15, e.g., includes a drawer 102 having two compartments, a drawer handle 102n, a main chamber 104, a drawer chamber (obscured in the figures), an outer housing 108, a lid 120, lock holes 120h of the lid 120, locks holes 108h of the outer housing 108, a lid lock 121, opposed side handles 124, a front handle 130, an upper housing 132, a lower housing (obscured in the figures), a vertically-extending divider wall (obscured in the figures) of the lower housing, insulating material (obscured in the figures), a drain 144, and a vertically-movable drawer lock 148.

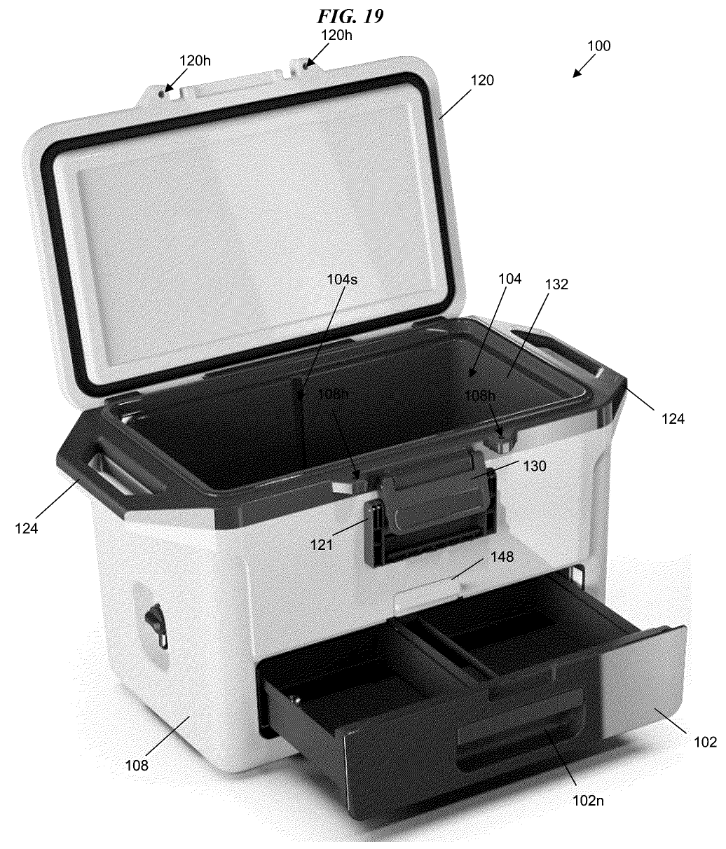

FIGS. 16-18 show each of the lid 120 and the drawer 102 closed, and FIG. 19 shows each of the lid 120 and the drawer 102 open. FIGS. 16-18 each show the lid lock 121 in the locked configuration, and FIG. 19 shows the lid lock 121 in the unlocked configuration. FIGS. 16-18 each show the drawer lock 148 in the locked configuration, and FIG. 19 shows the drawer lock 148 in the unlocked configuration. The drawer lock 148 in this illustrated embodiment includes an indicator 148i configured to indicate whether the drawer lock 148 is locked. The indicator 148i can have a variety of configurations, e.g., a color, text, a symbol, a light, etc. In this illustrated embodiment, the indicator 148i includes an area of the outer housing 108 in a first color that is configured to be visible with the drawer lock 148 in the locked configuration and that is configured to not be visible with the drawer lock 148 in the unlocked configuration. The first color is a different color than a color of the outer housing 108 at least in an area immediately surrounding the first color. The indicator 148i is therefore visible in FIGS. 16-18 and is not visible in FIG. 19.

The drawer handle 102n in this illustrated embodiment includes a depression formed in the front exterior surface of the drawer 102 and defining a hand or finger hold therein.

In this illustrated embodiment, the insulated container 100 does not include a vertically-extending divider wall in the main chamber 104. However, the main chamber 104 has a slot 104s formed therein in which a vertically-extending divider wall similar to the first divider wall 36 can be selectively received.

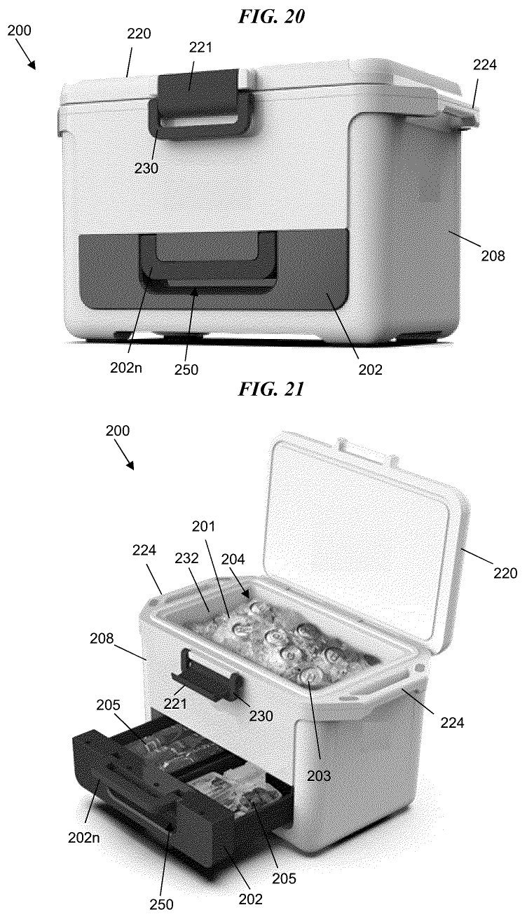

FIGS. 20 and 21 illustrate another embodiment of an insulated container 200 that includes a drawer 202. The insulated container 200 in this illustrated embodiment is generally configured and used similar to the insulated container 10 of FIGS. 1-15, e.g., includes a drawer 202 having two compartments, a drawer handle 202n, a main chamber 204, a drawer chamber (obscured in the figures), an outer housing 208, a lid 220, a lid lock 221, opposed side handles 224, a front handle 230, an upper housing 232, a lower housing (obscured in the figures), a vertically-extending divider wall (obscured in the figures) of the lower housing, a drawer lock, and insulating material (obscured in the figures).

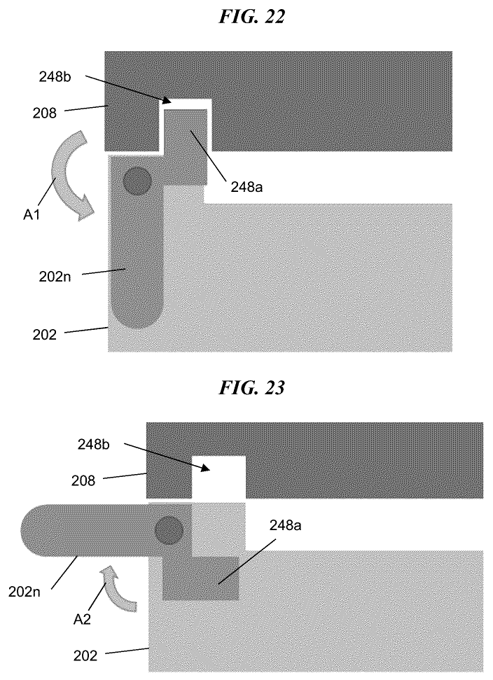

FIG. 20 shows each of the lid 220 and the drawer 202 closed, and FIG. 21 shows each of the lid 220 and the drawer 202 open. FIGS. 20 and 22 show the drawer lock in the locked configuration, and FIGS. 21 and 23 show the drawer lock in the unlocked configuration. The drawer lock in this illustrated embodiment includes a protrusion 248a extending from the drawer handle 202n and a first depression 248b formed in the outer housing 208. As shown in FIGS. 22 and 23, the drawer handle 202n is pivotally attached to the outer housing 208. The drawer handle 202n is configured to rotate in a first direction, e.g., counterclockwise as shown by an arrow A1 in FIG. 22, to move the drawer lock from the unlocked configuration to the locked configuration. With the drawer lock in the locked configuration, the protrusion 248a is seated in the first depression 248b and the drawer handle 202n is seated in a second depression 250 formed in a front exterior surface of the drawer 202. The protrusion 248a being seated in the first depression 248b prevents the drawer 202 from sliding or being pulled out of the outer housing 208. The drawer handle 202n is configured to rotate in a second, opposite direction, e.g., clockwise as shown by an arrow A2 in FIG. 23, to move the drawer lock from the locked configuration to the unlocked configuration. With the drawer lock in the unlocked configuration, the protrusion 248a is not seated in the first depression 248b and the drawer handle 202n is not seated in the second depression 250. The drawer 202 is thus free to slide or be pulled out of the outer housing 208.

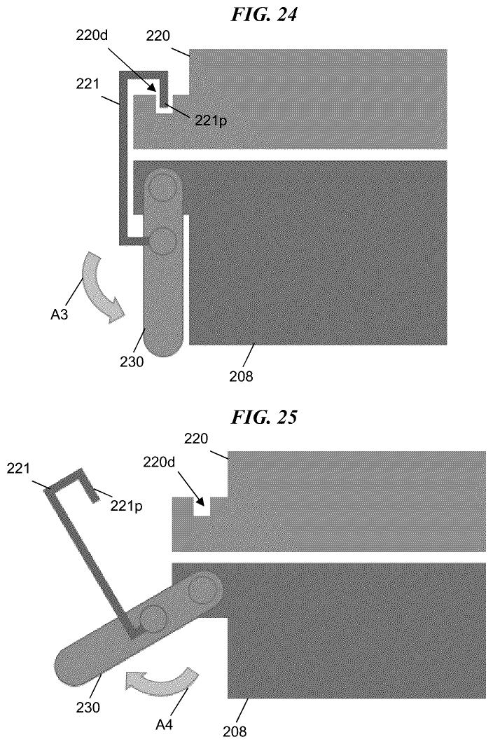

FIGS. 20 and 24 shows the lid lock 221 in the locked configuration, and FIGS. 21 and 25 show the lid lock 221 in the unlocked configuration. The lid lock 221 in this illustrated embodiment is configured to be selectively seated in a third depression 220d formed in the lid 220. As shown in FIGS. 24 and 25, the lid lock 221 is pivotally attached to the front handle 230, and the front handle 230 is pivotally attached to the outer housing 208. The front handle 230 is configured to rotate in a first direction, e.g., counterclockwise as shown by an arrow A3 in FIG. 24, to move the lid lock 221 from the unlocked configuration to the locked configuration. With the lid lock 221 in the locked configuration, a lip 221p of the lid lock 221 is seated in the third depression 220d. The lip 221p being seated in the third depression 220d prevents the lid 220 from opening. The front handle 230 is configured to rotate in a second, opposite direction, e.g., clockwise as shown by an arrow A4 in FIG. 25, to move the lid lock 221 from the locked configuration to the unlocked configuration. With the lid lock 221 in the unlocked configuration, the lip 221p is not seated in the third depression 220d. The lid 220 is thus free to be opened.

In this illustrated embodiment, the insulated container 200 does not include a vertically-extending divider wall in the main chamber 204. However, the main chamber 204 can have a slot therein similar to the slot 104s of FIG. 19.

A cooling agent 201 in the form of ice is shown in the main chamber 204 of the insulated container 200, although another type of cooling agent can be used instead of or in addition to ice. FIG. 21 also illustrates examples of one or more first items 203 contained in the main chamber 204 as metal beverage cans and examples of one or more second items 205 contained in the drawer 202 as metal beverage cans and plastic containers holding food.

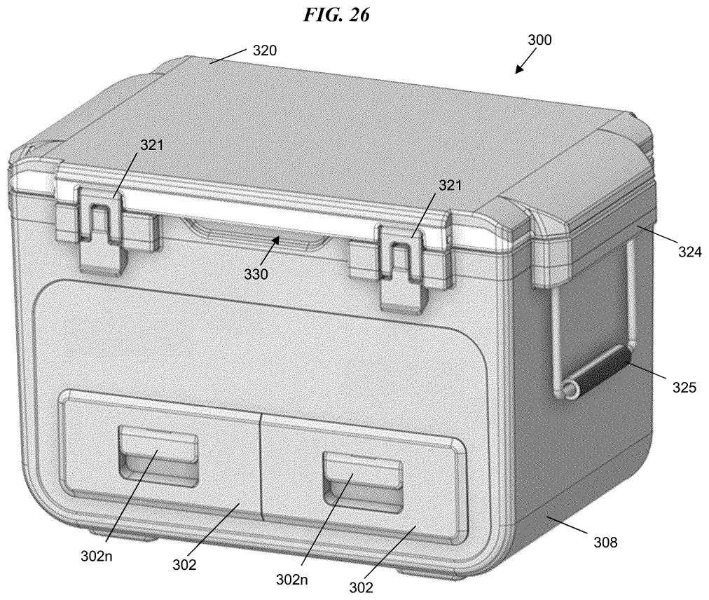

FIG. 26 illustrates another embodiment of an insulated container 300 that includes a drawer 302. The insulated container 300 in this illustrated embodiment is generally configured and used similar to the insulated container 10 of FIGS. 1-15, e.g., includes a drawer 302, a main chamber (obscured in FIG. 26), a drawer chamber (obscured in FIG. 26), an outer housing 308, a lid 320, a lid lock 321, opposed side handles 324 (one of the handles 324 is obscured in FIG. 26), a front handle 330, an upper housing (obscured in FIG. 26), a lower housing (obscured in FIG. 26), a vertically-extending divider wall (obscured in FIG. 26) of the lower housing, a vertically-extending divider wall (obscured in FIG. 26) of the upper housing, and insulating material (obscured in FIG. 26). FIG. 26 shows each of the lid 320 and the drawer 302 closed.

The drawer 302 in this illustrated embodiment includes first and second drawers that are configured to be opened and closed independent of one another. The drawer 302 thus defines two compartments but in two separate drawers instead of in a single drawer like the drawers 12, 102, 202 discussed above. Each of the two drawers includes its own handle 302n. The insulated container 300 includes a plurality of drawers instead of a single drawer may help maintain coolness in a closed one of the drawers with the other of the drawers being open. A single drawer like the drawers 12, 102, 202 discussed above may be easier and/or more cost effective to manufacture, such as using injection molding as discussed further below. Each of the drawers of FIG. 26 can be formed using injection molding but as separate elements instead of a single element like the drawers 12, 102, 202 discussed above.

The lid lock 321 in this illustrated embodiment includes first and second lid locks instead of a single lid lock like the lid locks 21, 121, 221 discussed above. Having more than one lid lock provides redundancy in case of lid lock failure. However, having more than one lid lock requires more user action than a single lid lock since more than one lid lock must be unlocked before the lid can be opened.

The handles 324 in this illustrated embodiment each include a pivotal handhold 325, similar to the strap, rope, or other member discussed above, engaged with at least one opening of each handle 324, similar to the openings 26 of FIG. 15 discussed above.

The front handle 330 in this illustrated embodiment includes a depression formed in the front exterior surface of the drawer outer housing 308 and defining a hand or finger hold therein.

An insulated container as described herein, e.g., the insulated container 10 of FIGS. 1-5, the insulated container 100 of FIGS. 16-19, the insulated container 200 of FIGS. 20 and 21, and the insulated container 300 of FIG. 26, can be manufactured in any of a variety of ways. In an exemplary embodiment, an insulating container as described herein is formed using injection molding.

Using injection molding to manufacture the insulated container may allow for finer details and tolerance control than other manufacturing methods, such as rotomolding (also referred to as rotational molding). For example, a bottom surface of an upper housing including a hexagonal rib structure as discussed above is possible to form using injection molding but would not be possible to form with as much fine detail and as much tolerance control using other manufacturing methods, such as rotomolding. Having a detailed hexagonal rib structure that allows for a very small manufacturing tolerance may help ensure that the hexagonal rib structure provides the durability and thermal effects discussed herein. For another example, a vertically-extending divider wall of a lower housing and a drawer having a corresponding shape configured to abut the lower housing's vertically-extending divider wall is possible to form using injection molding but would not be possible to form with as much fine detail and as much tolerance control using other manufacturing methods, such as rotomolding. Having a detailed vertically-extending divider wall of a lower housing and a drawer having a corresponding shape that allows for a very small manufacturing tolerance may help ensure that the drawer abuts the vertically-extending divider wall so as to minimize any thermal loss from within the drawer. For yet another example, guidance rail features of a drawer are configured to aid in opening and closing the drawer, as will be appreciated by a person skilled in the art. The drawer's guidance rail features, e.g., guidance rail features 12g on a side of the drawer as in the illustrated embodiment of FIG. 5, are configured to slide in corresponding guidance rail features of an outer housing, e.g., guidance rail features 18g of the outer housing 18 as shown in FIG. 5. Forming the drawer's and the lower housing's guidance rail features with the detail and tolerance control of injection molding may help ensure secure mating of the guidance rail features so as to minimize any thermal loss from within the drawer and/or may help smooth sliding of the drawer in and out of the lower housing's drawer chamber. For another example, forming a lid and an outer housing with injection molding may help ensure that a lid lock securely locks the lid in a closed configuration to maintain a complete seal of a main chamber within the outer housing (e.g., within an upper housing disposed within the outer housing) because of the fine detail and manufacturing control allowed by injection molding. For still another example, forming a drawer and an outer housing with injection molding may help ensure that a drawer lock securely locks the drawer in a closed configuration to maintain a complete seal of the drawer because of the fine detail and manufacturing control allowed by injection molding. For yet another example, forming an outer housing with injection molding may allow for a channel to be formed in the outer housing that is configured to seat therein a sealing gasket configured to help seal a closed drawer. The channel is also configured for detents to be mounted therein configured to engage corresponding indentations of a closed drawer and thereby help keep the drawer closed. The fine detail and tolerance control allowed by injection molding may help ensure that the sealing gasket seats securely therein to form as complete a seal as possible and may help ensure that the detents are of proper size and shape to engage the drawer. FIGS. 7 and 7A illustrate one embodiment of a sealing gasket 33, detents 35, and indentations 37.

Using injection molding to manufacture the insulated container may allow for individual components of the insulated container to be formed separately. Forming components separately may improve overall structural integrity of each individual component and thus overall structural integrity of the fully assembled insulated container. Forming components separately may improve cooling performance since a singular member does not have seams, joints, or other connection areas that would exist if the singular member was instead formed of two or more parts connected together. For example, forming an upper housing as a singular member may improve cooling performance since there are not seams, joints, or other connection areas in the upper housing through which coolness provided by a cooling agent in the main chamber can escape. For example, forming a drawer as a singular member may improve cooling performance since there are not seams, joints, or other connection areas in the drawer through which coolness in the drawer chamber can escape. Forming components separately may help prevent leaks since a singular member does not have seams, joints, or other connection areas where leaks are most likely to develop. For example, forming an upper housing as a singular member may help prevent melted ice from leaking out of the main chamber. For another example, forming a drawer as a singular member may help prevent liquid spilled out of a bottle in a first compartment of the drawer from leaking into a second compartment of the drawer or out of the drawer at all.

In general, an injection molding process includes injecting a molten material into a mold and then allowing the material to cool and harden in the mold. Injection molding is a relatively high pressure process since a compressive force is applied to the mold during the cooling and hardening process to help keep the mold closed. Also, the mold is still during the cooling and hardening process.

In general, a rotomolding process includes filling a mold with a material and heating the filled mold (e.g., in an oven) while the filled mold rotates. The filled mold is then removed from heat and allowed to cool so the material in the mold cools and hardens in the mold. Rotomolding is a relatively low pressure process since a compressive force is not applied to the mold during the rotating or cooling stages of rotomolding.

As discussed above, an insulated container can include an upper housing, a lower housing, an outer housing, a lid, and a drawer. In an exemplary embodiment, each of the upper housing, the lower housing, the outer housing, the lid, and the drawer are formed with injection molding. The material of the upper housing, the lower housing, the outer housing, the lid, and the drawer is polypropylene in an exemplary embodiment, although other materials are possible. Polypropylene has a high enough flow rate to be used in injection molding while also providing the rigidity needed for structural integrity of the insulated cooler. In some embodiments, a ultraviolet (UV) resistant material can be used to form at least the outer housing and/or can be used as a coating on the outer housing, which may help improve insulating properties of the insulated container.

Each of the upper housing, the lower housing, the outer housing, the lid, and the drawer is separately formed with injection molding so as to each be a singular member. After being formed, the upper housing, the lower housing, the outer housing, the lid, and the drawer are assembled along with other components of the insulated container, e.g., vertically-extending divider wall in the main chamber of the upper housing, insulating material, etc. The upper housing, the lower housing, the outer housing, the lid, and the drawer can be made in any order, and assembly of one or more of the upper housing, the lower housing, the outer housing, the lid, and the drawer may begin before one or more other components of the insulated container have been made.

In an exemplary embodiment, assembly of the insulated container includes fixedly securing the upper and lower housings together such that a bottom wall of the upper housing defines a top wall of a drawer chamber defined by the lower housing and such that the bottom wall separates the drawer chamber from a main chamber defined by the upper housing. As discussed above, with the upper and lower housings disposed in the outer housing, space is defined between the outer housing and the upper and lower housings. The assembly of the insulated container also includes filling the space with an insulating material. The insulating material is polyurethane foam in an exemplary embodiment, but other materials are possible. Further, in an exemplary embodiment, the same insulating material is used throughout the insulated container, but in some embodiments, an insulated container can include two or more different insulating materials.

Assembly of the insulated container also including coupling the drawer to the lower housing, e.g., disposed in the drawer in the drawer chamber. In an exemplary embodiment, the drawer is coupled to the lower housing after the lower housing has been fixedly secured to the upper housing and disposed in the outer housing and after insulating material has filled space defined between the outer housing and the upper and lower housings. A front space of the drawer is also filled with insulating material, as discussed above, which, in an exemplary embodiment, occurs prior to the drawer being coupled to the lower housing.

Assembly of the insulated container also including coupling the lid to the upper housing. In an exemplary embodiment, the lid is coupled to the upper housing after the upper housing has been fixedly secured to the lower housing and disposed in the outer housing and after insulating material has filled space defined between the outer housing and the upper and lower housings. The lid is also filled with insulating material, as discussed above, which, in an exemplary embodiment, occurs prior to the lid being coupled to the upper housing.

For insulated containers that include a removable vertically-extending divider wall in the main chamber, assembly of the insulated container also including disposing the vertically-extending divider wall in the main chamber. In an exemplary embodiment, the vertically-extending divider wall is disposed in the main chamber after the upper housing has been fixedly secured to the lower housing and disposed in the outer housing and after insulating material has filled space defined between the outer housing and the upper and lower housings.

One skilled in the art will appreciate further features and advantages of the devices, systems, and methods based on the above-described embodiments. Accordingly, this disclosure is not to be limited by what has been particularly shown and described, except as indicated by the appended claims. All publications and references cited herein are expressly incorporated herein by reference in their entirety for all purposes.

The present disclosure has been described above by way of example only within the context of the overall disclosure provided herein. It will be appreciated that modifications within the spirit and scope of the claims may be made without departing from the overall scope of the present disclosure.

What is claimed is:

1. A method of manufacturing an insulated container, comprising:
forming an upper housing of an insulated container with injection molding of polypropylene such that the upper housing is a singular member that has:
a main chamber therein, the main chamber being configured to receive a cooling agent that is configured to cool one or more first items removably contained in the main chamber,
an open upper end,
sidewalls that each has a thickness in a range of about 2.5 to about 3.5 mm, and
a bottom wall that has a thickness in a range of about 2.5 to about 3.5 mm and that includes a plurality of ribs;
forming a lower housing of the insulated container with injection molding of polypropylene such that the lower housing is a singular member that has:
a drawer chamber, the drawer chamber being configured to slidably receive a drawer therein that is configured to removably contain one or more second items therein,
sidewalls that each has a thickness in a range of about 2.5 to about 3.5 mm, and
an open upper end; and
fixedly securing the upper and lower housings together such that the bottom wall of the upper housing defines a top wall of the drawer chamber and separates the main chamber from the drawer chamber.

2. The method of claim 1, further comprising disposing a first vertically-extending divider wall in the upper housing such that the main chamber is divided into first and second compartments;
wherein the lower housing defines a second vertically-extending divider wall that:
extends a partial distance from back to front, and
with the upper and lower housings fixedly secured together, is below and vertically aligned with the first vertically-extending divider wall.

3. The method of claim 2, wherein the first vertically-extending divider wall and the second vertically-extending divider wall are centered laterally.

4. The method of claim 2, further comprising forming the drawer with injection molding of polypropylene; and
disposing the drawer in the drawer chamber such that first and second separate compartments of the drawer are disposed on either side of the second vertically-extending divider wall.

5. The method of claim 4, wherein a space is defined between an outer front face of the drawer and an interior wall of the drawer; and
the method further comprises filling the space with an insulating material.

6. The method of claim 4, wherein, with the drawer fully disposed in the drawer chamber, a back-facing surface of the drawer abuts a front-facing surface of the second vertically-extending divider wall and the drawer chamber is sealed closed.

7. An apparatus, comprising:
the insulated container manufactured by the method of claim 6.

8. The method of claim 1, further comprising forming the drawer with injection molding of polypropylene; and
disposing the drawer in the drawer chamber such that, with the drawer fully disposed in the drawer chamber, the drawer chamber is sealed closed;
wherein, with the upper and lower housings fixedly secured together, the drawer is configured to be slid at least partially out of the drawer chamber without breaking a seal of the main chamber.

9. The method of claim 1, further comprising forming the drawer with injection molding of polypropylene;
disposing the drawer in the drawer chamber; and
coupling a lock to the drawer, the lock being configured to be manually moved vertically between a locked configuration, in which the lock prevents the drawer from being slidable out of the drawer chamber, and an unlocked configuration, in which the lock allows the drawer to slide at least partially out of the drawer chamber.

10. The method of claim 1, further comprising disposing the upper and lower housings in an outer housing such that at least one first space is defined between the outer housing and the upper housing and at least one second space is defined between the outer housing and the lower housing; and
filling each of the at least one first space and the at least one second space with an insulating material.

11. The method of claim 10, wherein the insulating material includes polyurethane.

12. The method of claim 10, further comprising forming the drawer with injection molding of polypropylene;
wherein at least one third space is defined between an outer front face of the drawer and an interior wall of the outer housing; and
the method further comprises filling the at least one third space with the insulating material.

13. An apparatus, comprising:
the insulated container manufactured by the method of claim 12.

14. The method of claim 10, wherein the outer housing is formed of an ultraviolet (UV) resistant material or has a UV-resistant coating thereon.

15. The method of claim 1, further comprising coupling a lid to the upper housing such that the lid defines a top wall of the main chamber;
wherein the lid is configured to move between a closed configuration, in which the main chamber is sealed closed, and an open configuration, in which the main chamber is not sealed closed and the one or more first items removably contained in the main chamber are accessible to a user.

16. The method of claim 15, further comprising forming the drawer with injection molding of polypropylene;
disposing the drawer in the drawer chamber;
wherein, with the lid in the closed configuration and with the upper and lower housing fixedly secured together, the drawer is configured to be slid at least partially out of the drawer chamber without breaking a seal of the main chamber;
with the drawer fully disposed in the drawer chamber, the drawer chamber is sealed closed;
with the drawer chamber sealed closed and with the upper and lower housing fixedly secured together, the lid is configured to move from the closed configuration to the open configuration without breaking the seal of the drawer chamber.

17. An apparatus, comprising:
the insulated container manufactured by the method of claim 16.

18. The method of claim 1, wherein the sidewalls of the upper housing are substantially planar;
the sidewalls of the lower housing are substantially planar; and
the bottom wall of the upper housing is substantially planar and extends substantially perpendicularly to the sidewalls of the upper housing and to the sidewalls of the lower housing.

19. An apparatus, comprising:
the insulated container manufactured by the method of claim 1.

20. A method of manufacturing an insulated container, comprising:
forming an upper housing of an insulated container with injection molding of polypropylene such that the upper housing is a singular member that has:
a main chamber therein, the main chamber being configured to receive a cooling agent that is configured to cool one or more first items removably contained in the main chamber,
an open upper end, and
a bottom wall that includes a plurality of ribs;
forming a lower housing of the insulated container with injection molding of polypropylene such that the lower housing is a singular member that has:
a drawer chamber therein that is configured to slidably receive a drawer therein that is configured to removably contain one or more second items therein, and
an open upper end;
fixedly securing the upper and lower housings together such that the bottom wall of the upper housing defines a top wall of the drawer chamber and separates the main chamber from the drawer chamber;
coupling a lid to the upper housing such that the lid defines a top wall of the main chamber;
forming the drawer with injection molding of polypropylene; and
disposing the drawer in the drawer chamber such that, with the drawer fully disposed in the drawer chamber, the drawer chamber is sealed closed;
wherein the lid is configured to move between a closed configuration, in which the main chamber is sealed closed, and an open configuration, in which the main chamber is not sealed closed and the one or more first items removably contained in the main chamber are accessible to a user;
with the upper and lower housing fixedly secured together, the drawer is configured to be slid at least partially out of the drawer chamber without breaking the seal of the main chamber; and
with the drawer chamber sealed closed and with the upper and lower housings fixedly secured together, the lid is configured to move from the closed configuration to the open configuration without breaking the seal of the drawer chamber.

21. An apparatus, comprising:
the insulated container manufactured by the method of claim 20.
